(19) United States
(12) Patent Application Publication
(10) Pub. No.: US 2016/0198097 A1
(43) Pub. Date: Jul. 7, 2016

(54) SYSTEM AND METHOD FOR INSERTING OBJECTS INTO AN IMAGE OR SEQUENCE OF IMAGES

(71) Applicant: GenMe, Inc., Los Angeles, CA (US)

(72) Inventors: Christopher Michael Yewdall, Playa Vista, CA (US); Kevin John Stec, Lake Arrowhead, CA (US); Peshala Vishvajith Pahalawatta, Burbank, CA (US); Julien Flack, Swanbourne (AU)

(21) Appl. No.: 14/987,665

(22) Filed: Jan. 4, 2016

Related U.S. Application Data
(60) Provisional application No. 62/099,949, filed on Jan. 5, 2015.

(51) Int. Cl. H04N 5/265; G06T 7/00

(52) U.S. Cl. CPC H04N 5/265; G06T 7/004; G06T 7/0051

(57) ABSTRACT

An object image or video of one or more person(s) is captured, the background information is removed, the object image or video is inserted into a still image, video, or video game using a depth layering technique and the composited final image is shared with a user's private or social network(s). A method for editing the insertion process is part of the system to allow for placing the object image in both depth and planar locations, tracking the placement from frame to frame and resizing the object image. Graphic objects may also be inserted during the editing process. A method for tagging the object image is part of the system to allow for identification of characteristics when the content is shared for subsequent editing and advertising purposes.

### CROSS REFERENCE TO RELATED APPLICATIONS

This application claims priority under 35 U.S.C. §119(e) to U.S. Provisional Application No. 62/099,949, entitled “SYSTEM AND METHOD FOR INSERTING OBJECTS INTO AN IMAGE OR SEQUENCE OF IMAGES,” filed Jan. 5, 2015, the entirety of which is hereby incorporated by reference.

### FIELD

This disclosure is generally related to image and video compositing. More specifically, the disclosure is directed to a system for inserting a person into an image or sequence of images and sharing the result on a social network.

### BACKGROUND

Compositing of multiple video sources along with graphics has been a computational and labor intensive process reserved for professional applications. Simple consumer applications exist, but may be limited to overlaying of an image on top of another image. There is a need to be able to place a captured person or graphic object on to and within a photographic, video, or game clip.

### SUMMARY

Various implementations of systems, methods and devices within the scope of the appended claims each have several aspects, no single one of which is solely responsible for the desired attributes described herein. In this regard, embodiments of the present disclosure may be embodied in many different forms and should not be construed as being limited to the embodiments set forth herein. Without limiting the scope of the appended claims, some prominent features are described herein.

An apparatus for adding image information into at least one image frame of a video stream is provided. The apparatus comprises a storage circuit for storing depth information about first and second objects in the at least one image frame. The apparatus also comprises a processing circuit configured to add a third object into a first planar position. The third object is added at an image depth level of the at least one image frame based on selecting whether the first or second object is a background object. The processing circuit is further configured to maintain the third object at the image depth level in a subsequent image frame of the video stream. The image depth level is consistent with the selection of the first or second object as the background object. The processing circuit is further configured to move the third object from the first planar position to a second planar position in a subsequent image frame of the video stream. The second planar position is based at least in part on the movement of an object associated with a target point.

A method for adding image information into at least one image frame of a video stream is also provided. The method comprises storing depth information about first and second objects in the at least one image frame. The method further comprises adding a third object into a first planar position. The third object is added at an image depth level of the at least one image frame based on selecting whether the first or second object is a background object. The method further comprises maintaining the third object at the image depth level in a subsequent image frame of the video stream. The image depth level is consistent with the selection of the first or second object as the background object. The method further comprises moving the third object from the first planar position to a second planar position in a subsequent image frame of the video stream. The second planar position is based at least in part on movement of an object associated with a target point.

An apparatus for adding image information into at least one image frame of a video stream is also provided. The apparatus comprises a means for storing depth information about first and second objects in the at least one image frame. The apparatus further comprises a means for adding a third object into a first planar position. The third object is added at an image depth level of the at least one image frame based on selecting whether the first or second object is a background object. The apparatus further comprises a means for maintaining the third object at the image depth level in a subsequent image frame of the video stream. The image depth level is consistent with the selection of the first or second object as the background object. The apparatus further comprises a means for moving the third object from the first planar position to a second planar position in a subsequent image frame of the video stream. The second planar position is based at least in part on movement of an object associated with a target point.

### BRIEF DESCRIPTION OF THE DRAWINGS

FIG. 1 shows a functional block diagram of a depth-based compositing system, according to one or more embodiments.

FIG. 2 shows a functional block diagram of the processing circuit and the output medium of FIG. 1 in further detail.

FIG. 3A shows an exemplary image frame provided by the content source of FIG. 2.

FIG. 3B shows the image frame having uncombined exemplary depth-layers, in accordance with one or more embodiments.

FIGS. 4A-4E show a person in an exemplary object image with the background removed, and show an insert layer inserted within the depth-layers of the image frame of FIGS. 3A-3B, in accordance with one or more embodiments.

FIGS. 5A-5E show the person within the object image and a graphic object(s) of a submarine composited into another exemplary image frame, in accordance with one or more embodiments.

FIGS. 6A-6C show the person of FIGS. 4A-4E composited into the image frame of FIGS. 3A-3B.

FIGS. 7A-7C show the person and image frame of FIGS. 6A-6C, and an exemplary depth-based position controller and an exemplary planar-based position controller on a touchscreen device.

FIGS. 8A-8B shows the person of FIGS. 6A-6C that is resized by movements of a user's fingers while composited into an image frame.

FIGS. 9A-9I show an exemplary selection of a scene object (the car) in the image frame.

FIG. 10 is a flowchart of a method for updating a bounding cube of the scene object in the image frame.

FIG. 11 shows a flowchart of a method for selecting draw modes for rendering objects composited into a video image.

FIG. 12 shows exemplary insertions of multiple object images composited into an image frame using metadata.

### DETAILED DESCRIPTION

Various aspects of the novel systems, apparatuses, and methods are described more fully hereinafter with reference to the accompanying drawings. The teachings of the disclosure may, however, be embodied in many different forms and should not be construed as limited to any specific structure or function presented throughout this disclosure. Rather, these aspects and embodiments are provided so that this disclosure will be thorough and complete, and will fully convey the scope of the disclosure. The scope of the disclosure is intended to cover any aspect of the novel systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Although particular embodiments are described herein, many variations and permutations of these embodiments fall within the scope of the disclosure. Although some benefits and advantages of the embodiments are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following description of the embodiments. The detailed description and drawings are merely illustrative of the disclosure rather than limiting, the scope of the disclosure being defined by the appended claims and equivalents thereof.

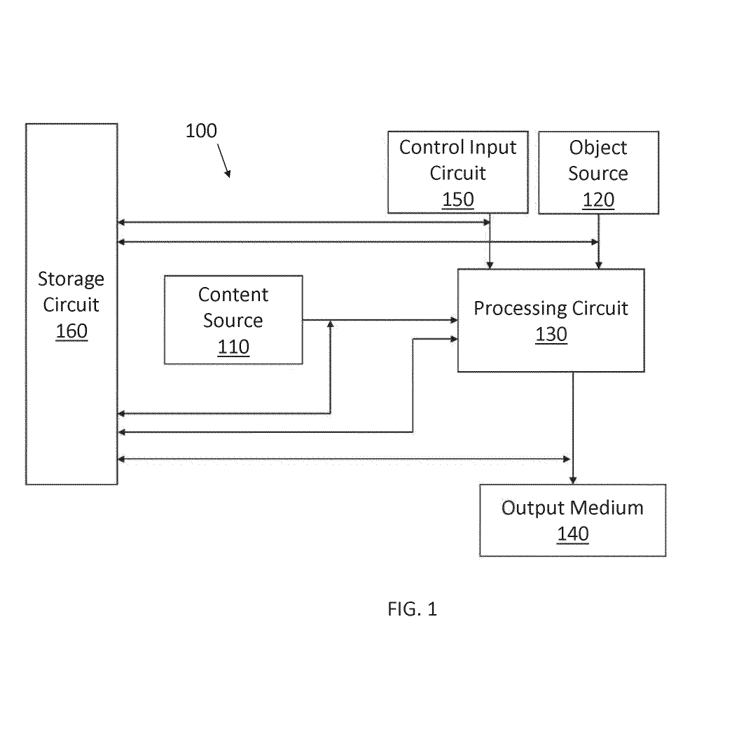

FIG. 1 shows a functional block diagram of a depth-based compositing system 100, according to one or more embodiments. The following description of the components provides the depth-based compositing system 100 with the capability to perform its functions as described below.

According to one embodiment, the depth-based compositing system 100 comprises a content source 110 coupled to the processing circuit 130. The content source 110 is configured to provide the processing circuit 130 with an image(s) or video(s). In one embodiment, the content source 110 provides the one or more image frames that will be the medium in which an image(s) or video(s) of an object source 120 will be inserted. The image(s) or video(s) from the content source 110 will be referred to herein as “Image frame”. For example, the content source 110 is configured to provide one or more video clips from a variety of sources, such as broadcast, movie, photographic, computer animation, or a video game. The video clips may be of a variety of formats, including two-dimensional (2D), stereoscopic, and 2D+depth video. Image frame from a video game or a computer animation may have a rich source of depth content associated with it. A Z-buffer may be used in the computer graphics process to facilitate hidden surface removal and other advanced rendering techniques. A Z-buffer generally refers to a memory buffer for computer graphics that identifies surfaces that may be hidden from the viewer when projected on to a 2D display. The processing circuit 130 may be configured to directly use the depth-layer data in the computer graphics process's z-buffer by the depth-based compositing system 100 for depth-based compositing. Some games may be rendered in a layered framework rather than a full 3D environment. In this context, the processing circuit 130 may be configured to effectively construct the depth-layers by examining the depth-layers that individual game objects are rendered on.

According to one embodiment, the depth-based compositing system 100 further comprises the object source 120 that is coupled to the processing circuit 130. The object source 120 is configured to provide the processing circuit 130 with an image(s) or video(s). The object source 120 may provide the object image that will be inserted into the image frame. Image(s) or video(s) from the object source 120 will be referred to herein as “Object Image”. In one embodiment of the present invention, the object source 120 is further configured to provide graphic objects. The graphic objects may be inserted into the image frame in the same way that the object image may be inserted. Examples of graphic objects include titles, captions, clothing, accessories, vehicles, etc. Graphic objects may also be selected from a library or be user generated. According to another embodiment, the object source 120 is further configured to use a 2D webcam capture technique to capture the object image to be composited into depth-layers. The objective is to leverage 2D webcams in PCs, tablets, smartphones, game consoles and an increasing number of Smart televisions (TVs). In another embodiment, a high quality webcam is used. The high quality webcam is capable of capturing up to 4k or more content at 30 fps. This allows the webcam to be robust in lower light conditions typical of a consumer workspace and with a low level of sensor noise. The webcam may be integrated into the object source 120 (such as within the bezel of a PC notebook, or the forward facing camera of a smartphone) or be a separate system component that is plugged into the system (such as an external universal serial bus (USB) webcam or a discrete accessory). The webcam may be stationary during acquisition of the object image to facilitate accurate extraction of the background. However, the background removal circuit 240 may also be robust enough to extract the background with relative motion between the background and the person of the object image. For example, the user acquires video while walking with a phone so that the object image is in constant motion.

The processing circuit 130 may be configured to control operations of the depth-based compositing system 100. For example, the processing circuit 130 is configured to create a final image(s) or video(s) by inserting the object image provided by the object source 120 into the image frame provided by the content source 110. The final image(s) or video(s) created by the processing circuit 130 will be referred to as “Final image”. In an embodiment, the processing circuit 130 is configured to execute instruction codes (e.g., in source code format, binary code format, executable code format, or any other suitable format of code). The instructions, when executed by the processing circuit 130, perform depth-based compositing as described herein. The processing circuit 130 may be implemented with any combination of processing circuits, general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. In an example, the processing circuit 130 is run locally on a personal device, such as a PC, tablet, or smartphone, or on a cloud-based application that is controlled from a personal device.

According to one embodiment, the depth-based compositing system 100 further comprises a control input circuit 150. The control input circuit 150 is coupled to the processing circuit 130. The control input circuit 150 may be configured to receive input from a user and may be configured to send the signal to the processing circuit 130. The control input circuit 150 provides a way for the user to control how the depth-based compositing is performed. For example, the user may use a pointing device on a PC or by a finger movement on a touchscreen device or by hand and finger gesture on a device equipped with gesture detection. In one embodiment, the control input circuit 150 is configured to allow the user to control positioning of the object image spatially in the image frame when the processing circuit 130 performs depth-based compositing. In an alternative or additional embodiment, a non-user (e.g. a program or other intelligent source) may provide input to the control input circuit 150.

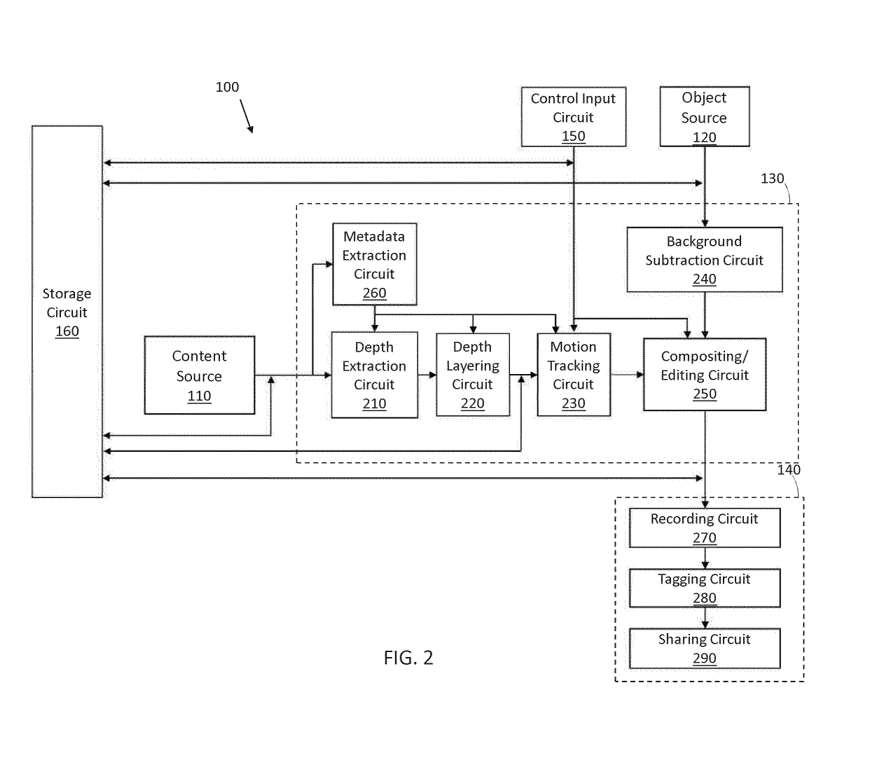

The control input circuit 150 may further be configured to control the depth of the object image. In one embodiment, the control input circuit 150 is configured to receive a signal from a device (not shown in FIG. 1 or 2) whereby the user uses a slider or similar control to vary the relative depth position of the object image to the depth planes of the image frame. Depending on the depth position and the objects in the image frame, portions of the object image may be occluded by objects in the image frame that are located in front of the object image.

The control input circuit 150 may also be configured to control the size and orientation of the object image relative to objects in the image frame. The user provides an input to the control input circuit 150 to control the size, for example, a slider or a pinching gesture (e.g., moving two fingers closer together to reduce the size or further apart to increase the size) on a touchscreen device or gesture detection equipped device. When the object image includes video, editing may be done in real-time, at a reduced frame rate, or on a paused frame. The image frame and/or object image may or may not include audio. If audio is included, the processing circuit 130 may mix the audio from the image frame with the audio from the object image. The processing circuit 130 may also dub the final image during the editing process.

According to one embodiment, the depth-based compositing system 100 further comprises the storage circuit 160. The storage circuit 160 may be configured to store the image frame from the content source 110 or the object image from the object source 120, user inputs from the control input circuit 150, data retrieved throughout the depth-based compositing within the processing circuit 130, and/or the final image created by the processing circuit 130. The storage circuit 160 may store for very short periods of time, such as in a buffer, or for extended periods of time, such as on a hard drive. In one embodiment, the storage circuit 160 comprises both read-only memory (ROM) and random access memory (RAM) and provides instructions and data to the processing circuit 130 or the control input circuit 150. A portion of the storage circuit 160 may also include non-volatile random access memory (NVRAM). The storage circuit 160 may be coupled to the processing circuit 130 via a bus system. The bus system may be configured to couple each component of the depth-based compositing system 100 to each other component in order to provide information transfer.

According to one embodiment, the depth-based compositing system 100 further comprises an output medium 140. The output medium 140 is coupled to the processing circuit 130. The processing circuit 130 provides the output medium 140 with the final image. In one embodiment, the output medium 140 records, tags, and shares the final image to a network, social media, user's remote devices, etc. For example, the output medium 140 may be a computer terminal, a web server, a display unit, a memory storage, a wearable device, and/or a remote device.

FIG. 2 shows a functional block diagram of the processing circuit 130 and the output medium 140 of FIG. 1 in further detail. In one embodiment, the processing circuit 130 further comprises a metadata extraction circuit 260. The content source 110 provides the image frame to the metadata extraction circuit 260. In one embodiment, the metadata extraction circuit 260 extracts the metadata from the image(s) or video(s) and send the metadata to a depth extraction circuit 210, a depth-layering circuit 220, a motion tracking circuit 230, or other circuits or functional blocks that perform the depth-based compositing. For example, metadata may include positional or orientation information of the object image, and/or layer information of the image frame. The metadata from the metadata extraction circuit 260 provide other functional blocks with information stored in the image frame that helps with the process of depth-based compositing. In another example, the image frame contains a script that includes insertion points for the object image.

According to one embodiment, the processing circuit 130 further comprises the depth extraction circuit 210 and the depth-layering circuit 220. The depth layering circuit 220 is coupled to the depth extraction circuit 210, the metadata extraction circuit 260, and the motion tracking circuit 230. The depth extraction circuit 210 may receive the image frame from the content source 110. In one embodiment, the depth extraction circuit 210 and the depth-layering circuit 220 extracts and separates the image frame into multiple depth-layers so that a compositing/editing circuit 250 may insert the object image into an insert layer that is located within the multiple depth-layers. The compositing/editing circuit 250 may then combine the insert layer with the other multiple depth-layers to generate the final image. Depth extraction generally refers to the process of creating depth value for one or more pixels in an image. Depth layering, on the other hand, generally refers to the process of separating an image into a number of depth layers based on the depth value of pixels. Generally, a depth layer will contain pixels with a range of depth values.

According to one embodiment, the processing circuit 130 further comprises a background subtraction circuit 240. The background subtraction circuit 240 receives the object image from the object source 120 and removes the background of the object image. The background may be removed so that just the object may be inserted into the image frame. The background subtraction circuit 240 may be configured to remove the background using depth based techniques described in the US Pat. Pub. No. US20120069007 A1, which is herein incorporated by reference in its entirety. For example, the background subtraction circuit 240 refines an initial depth map estimate by detecting and tracking an observer's face, and models the position of the torso and body to generate a refined depth model. Once the depth model is determined, the background subtraction circuit 240 selects a threshold to determine which depth range represents foreground objects and which depth range represents background objects. The depth threshold may be set to ensure the depth map encompasses the detected face in the foreground region. In an alternative embodiment, alternative background removal techniques may be used to remove the background, for example, as those described in U.S. Pat. No. 7,720,283 to Sun, which is herein incorporated by reference in its entirety.

According to one embodiment, the processing circuit 130 further comprises the motion tracking circuit 230. The motion tracking circuit 230 receives the layers from the depth-layering circuit 220 and a control signal from the control input circuit 150. In one embodiment, the motion tracking circuit 230 is configured to determine how to smoothly move the object image in relation to the motion of other objects in the image frame. In order to do so, the object image is displaced from one frame to the next frame by an amount that is substantially commensurate with the movement of other nearby objects of the image frame.

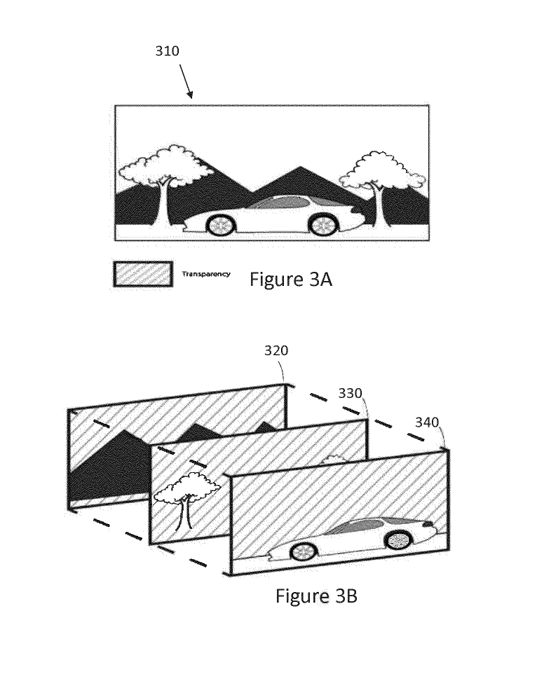

According to one embodiment, the processing circuit 130 further comprises the compositing/editing circuit 250. The compositing/editing circuit 250 is configured to insert the object image into the image frame. In one embodiment, the object image is inserted into the image frame by first considering the alpha matte for the object image provided by the threshold depth map. The term ‘alpha’ generally refers to the transparency (or conversely, the opacity) of an image. An alpha matte generally refers to an image layer indicating the alpha value for each image pixel to the processing circuit 130. Image composition techniques are used to insert the object image with the alpha matte into the image frame. The object image is overlaid on top of the image frame such that pixels of the object image obscure any existing pixels in the image frame, unless the object image pixel is transparent (as is the case when the depth map has reached its threshold). In this case, the pixel from existing image is retained. This reduces the number of frames needed to have insertion positions identified to just a few key frames or only the starting position. The image frame may already have the insertion positions marked by metadata or may include metadata for motion tracking provided by the metadata extraction circuit 260. Alternatively or additionally, the motion tracking circuit 230 may mark the image frame to signify the location. The marking of the object image may be inserted by placing a small block in the image frame that the processing circuit 130 may recognize. This may be easily detected by an editing process. This also survives high levels of video compression. In order to achieve a more pleasing final image, the compositing/editing circuit 250 uses edge blending, color matching and brightness matching techniques to provide the final image with a similar look as the image frame, according to one or more embodiments. The processing circuit 130 may be configured to use the depth-layers in a 2D+depth-layer format to insert the object image (not shown in FIGS. 3A-3B) into the image frame. The 2D+depth-layer format is a stereoscopic video coding format that is used for 3D displays. According to another embodiment, the compositing/editing circuit 250 inserts the object image with the background removed by the background subtraction circuit 240 into the image frame. In one embodiment, the inserted object image is placed centered on top of the image frame as a default location. The object image and the image frame may have different spatial resolution. The processing circuit 130 may be configured to create a pixel map of the object image to match the pixel spacing of the image frame. The compositing/editing circuit 250 may be configured to ignore any information outside of the frame boundaries in the compositing process. If the size of the object image is less than the size of the image frame, then the compositing/editing circuit 250 may treat the missing pixels as transparent pixels in the compositing process. This default location and size of the object image is unlikely to be the desired output, so editing controls are desired to allow the user to move the object image to the desired position both spatially and in depth and to resize the object image.

According to another embodiment, the processing circuit 130 includes audio with the image frame and the object image. If both the image frame and object image include audio, then the processing circuit 130 mixes the audio sources to provide a combined output. The processing circuit 130 may also share the location information from the person in the object image with the audio mixer so that the processing circuit 130 may pan the person's voice to follow the position of the person. For greater accuracy, the processing circuit 130 may use a face detection process to provide additional information on the approximate location of the person's mouth. In a stereo mix, for example, the processing circuit 130 positions the person from left to right. In a surround sound or object based mix, in an alternative or additional example, the processing circuit 130 shares planar and depth location information of the person (or graphic object) of the object image with the audio mixer to improve the sound localization.

One or more functions described in correlation with FIGS. 1-2 may be performed in real-time or non-real-time depending on the application requirements.

According to one embodiment, the processing circuit 130 further comprises a recording circuit 270. The recording circuit 270 may receive the final image from the processing circuit 130 and store the final image. One purpose of the recording circuit 270 is for the network to be able to retrieve the final image at any time to tag the final image by the tagging circuit 280 and/or share or post by a sharing circuit 290 the final image on social media.

According to one embodiment, the processing circuit 130 further comprises the tagging circuit 280. The tagging circuit 280 receives the stored final image from the tagged circuit 280 and tags the final image with metadata that describes characteristics of the insert image and the image frame. For example, this tagging helps with correlation of the final image with characteristics of the social media to make the final image more related to the users, the profiles, the viewers, and/or the purpose of the social media. This metadata may be demographic information related to the inserted person such as age group, sex, physical location; information related to an inserted object or objects such as brand identity, type and category; or information related to the image frame such as the type of content or the name of the program or video game that the clip was extracted from.

According to one embodiment, the processing circuit 130 further comprises the sharing circuit 290. The sharing circuit 290 receives the stored final image with the tagged metadata from the tagging circuit 280. The sharing circuit 290 shares the final image over a network(s) (not shown in FIG. 2) used for distribution of the final image. This information may be useful to the originators of the image frame and/or advertisers or for identifying video clips with particular characteristics.

FIG. 3A shows an exemplary image frame 310 provided by the content source 110 of FIG. 2. The depth extraction circuit 210 and the depth-layering circuit 220 may receive the content source 110, and extract and separate the image frame 310 into multiple depth-layers 320, 330, and 340.

FIG. 3B shows the image frame 310 of FIG. 3A having uncombined exemplary depth-layers 320, 330, and 340, in accordance with one or more embodiments. As described in connection with FIG. 2, the compositing/editing circuit 250 may later use the depth-layers 320, 330, and 340 to determine where to insert the object image. The content source 110 may provide the image frame 310 with insertion positions marked by metadata or may include metadata for motion tracking provided by the metadata extraction circuit 260. Other circuit compositions may in turn use the metadata to identify the different depth-layers 320, 330, and 340 for use in the insertion of the object image. In an alternative or additional embodiment, the processing circuit 130 creates and/or extracts depth-layers 320, 330, and 340 from the image frame 310 using a number of methods. For example, the processing circuit 130 renders the depth-layers 320, 330, and 340 along the image frame 310. The processing circuit 130 may further be configured to acquire or generate depth information for generating the depth-layers 320, 330, and 340 using a number of different techniques, for example, time-of-flight cameras, structured-light systems and depth-from-stereo hardware improve the human computer interface. Generally, a time-of-flight camera produces a depth output by measuring the time it takes to receive a reflected light from an emitted light source for each object in a captured scene. A structured-light camera generally refers to a camera that emits a pattern of light over a scene; the distortion in the captured result is then used to calculate depth information. Depth-from-stereo hardware generally measures the disparity of objects in each view of the image and uses a camera model to convert the disparity values to depth. The processing circuit 130 may create the depth-layers 320, 330, and 340 using techniques for converting 2D images into stereoscopic 3D images or through the use of image segmentation tools Image segmentation tools generally group neighboring pixels with similar characteristics in segments or superpixels. These image segments may represent parts of meaningful objects that can be used to make inferences about the contents of the image. One example, amongst others, of a segmentation algorithm is Simple Linear Iterative Clustering (SLIC). The processing circuit 130 may also use stereo acquisition systems to extract and/or generate depth-layers 320, 330, and 340 from high quality video footage. Stereo acquisition systems generally use two cameras with a horizontal separation to capture a stereo pair of images. Other camera systems save costs by using two lenses with a single pick-up.

In this example, the depth-layers 320, 330, and 340 are described or positioned as a back layer 320, a middle layer 330, and a front layer 340. The back layer 320 contains a mountain terrain, the middle layer 330 contains trees, and the front layer 340 contains a car. As described in FIG. 2, the depth layering circuit 220 may send the depth-layers 320, 330, and 340 to the motion tracking circuit 230, and the motion tracking circuit 230 may send the depth-layers 320, 330, and 340 to the compositing/editing circuit 250. According to another embodiment, the compositing/editing circuit 250 uses the depth-layers 320, 330, and 340 to sort pixels within the image frame 310 into different depth ranges. The compositing/editing circuit 250 assigns each pixel in the image frame 310 to fall within a pixel in one of the depth-layers 320, 330, and 340. The pixels are assigned to create the desired separation of objects within the image frame 310. Accordingly, each assigned pixel in the depth-layers 320, 330, and 340 may be found in the image frame 310.

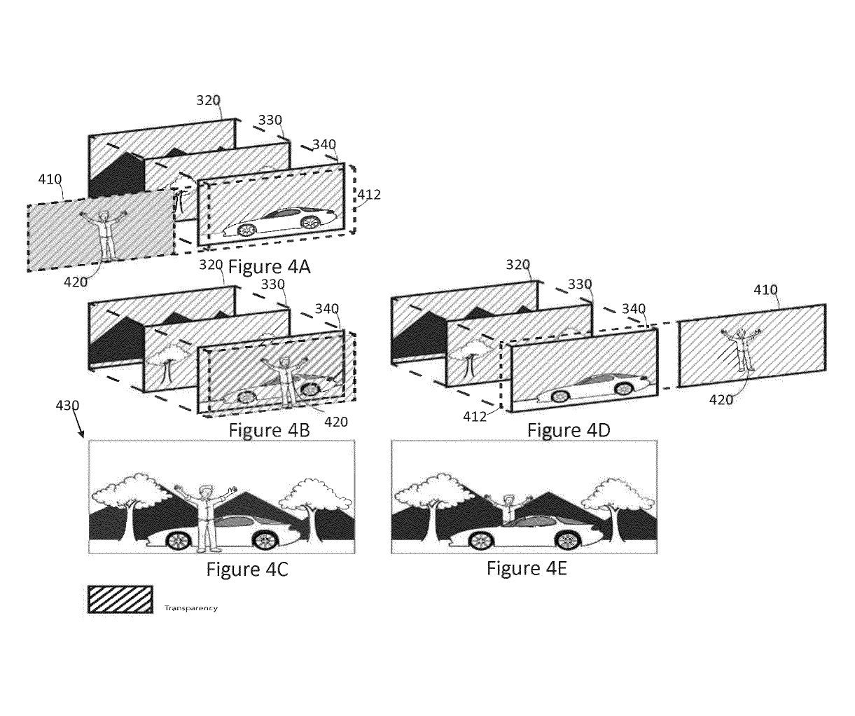

FIGS. 4A-4E show a person 420 in an exemplary object image 410 with the background removed, and show an insert layer 412 inserted within the depth-layers 320, 330, and 340 of the image frame 310 of FIGS. 3A-3B, in accordance with one or more embodiments.

FIG. 4A shows the depth-layers 320, 330, and 340 of FIG. 3B. FIG. 4A also shows the person 420 in the object image 410 with the background removed by the background subtraction circuit 240 of FIG. 2 and the exemplary insert layer 412. The insert layer 412 is located in front of the front layer 340. As described in FIG. 2, the motion tracking circuit 230 or the compositing/editing circuit 250 may determine the depth of the insert layer 412. Accordingly, when the insert layer 412 with the object image 410 is inserted, the object image 410 is positioned in front of the front layer 340.

FIG. 4B shows the depth-layers 320, 330, and 340 of FIG. 4A and the person 420 in the exemplary object image 410 inserted into the insert layer 412. The insert layer 412 is positioned in front of the front layer 340, as described in FIG. 4A. One way of inserting the insert layer 412 in front of the front layer 340 is to replace pixel values of the front layer 340, the middle layer 330, and the back layer 320 with overlapping pixels of the person 420 in the insert layer 412. The pixels in the front layer 340, the middle layer 330, and the back layer 320 that are not overlapping with the pixels of the person 420 in the insert layer 412 may remain intact. FIG. 4C shows an exemplary final image 430 created by compositing, by the compositing/editing circuit 250, the object image 410 with the insert layer 412 located in front of the front layer 340. Accordingly, the person 420 of the object image 410 is in front of the car of the front layer 340, the trees of the middle layer 330, and the mountain terrain of the back layer 320.

FIG. 4D shows the depth-layers 320, 330, and 340, the person 420 in the object image 410, and the insert layer 412 of FIG. 4A. The insert layer 412 is located in between the front layer 340 and the middle layer 330. One way of inserting the insert layer 412 may be similar to the method described in FIG. 4B, except that only the pixel values of the middle layer 330 and the back layer 320 are replaced by the overlapping pixels of the person 420 in the insert layer 412. Accordingly, the pixels in the middle layer 330 and the back layer 320 that are not overlapping with the pixels of the person 420 in the insert layer 412 may remain intact. Also, all pixels in the front layer 340 remain intact, and pixels in the front layer 340 obscure overlapping pixels of the person 420 in the layer 422. FIG. 4E shows the exemplary final image 430 created by compositing, by the compositing/editing circuit 250, the object image 410 with the insert layer 412 located in between the front layer 340 and the middle layer 330. Accordingly, the person 420 of the object image 410 is behind the car of the front layer 340 but in front of the trees of the middle layer 330 and the mountain terrain of the back layer 320. In one embodiment, the user changes the size of the object image 410 to better match the scale of the image frame 310. The final image 430 may be sent to the output medium 140 in FIG. 1.

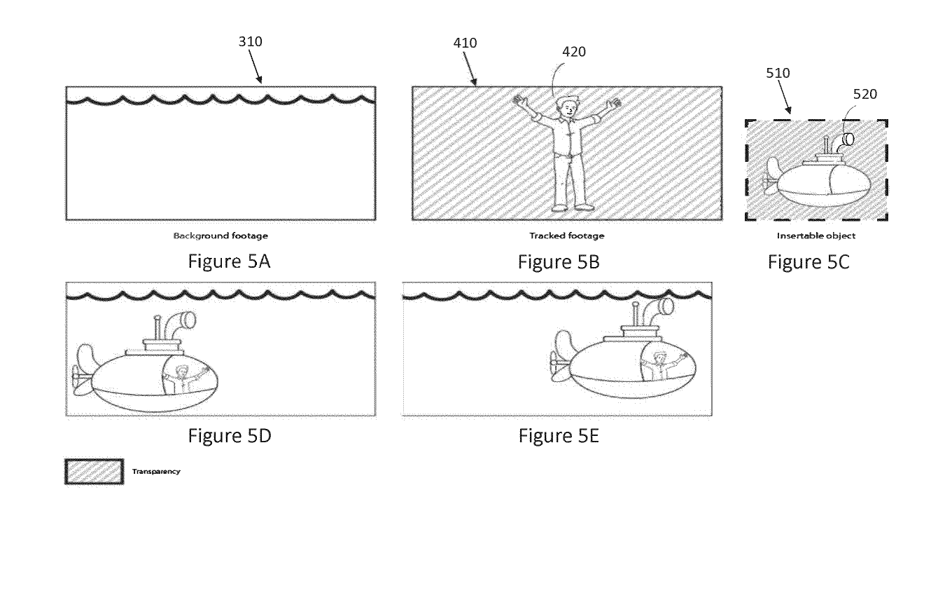

FIGS. 5A-5E show the person 420 within the object image 410 and a graphic object(s) 510 of a submarine 520 composited into another exemplary image frame 310, in accordance with one or more embodiments. FIG. 5A shows the exemplary image frame 310, where the object image 410 and the graphic object 510 will be inserted. FIG. 5B shows the object image 410 with the background removed by the background subtraction circuit 240 of FIG. 2. Background subtraction generally refers to a technique for identifying a specific object in a scene and removing substantially all pixels that are not part of that object. For example, the technique may be applied to images containing a human person. The process may be used to find all pixels that are part of the human figure and remove all pixels that are not part of the human figure. FIG. 5C shows the graphic object(s) 510 also with the background removed by the background subtraction circuit 240 of FIG. 2. The object source 120 of FIG. 1 may provide the object image 410 and the graphic object(s) 510. Examples of graphic object(s) 510 include titles, captions, clothing, accessories, vehicles, etc. In an alternative or additional embodiment, the object source 120 selects the graphic object(s) 510 from a library or may be user generated. In FIG. 5D, the compositing/editing circuit 250 may composite the person 420 and the submarine 520, whereby the front of the submarine 520 of FIG. 5C has a semi-transparent dome where the person 420 of FIG. 5B is resized and placed to appear to be inside of the submarine 520 of FIG. 5C. Compositing generally refers to a technique for overlaying multiple images, with transparent regions over one another according to, for instance, one of the methods described in connection with FIG. 2. As shown in FIG. 5E, the person 420 and submarine 520 may move together in subsequent frames of the image frame 310. The compositing/editing circuit 250 may composite the person 420 and the submarine 520 into the image frame 310 and create a final image 430 to be sent to the output medium 140.

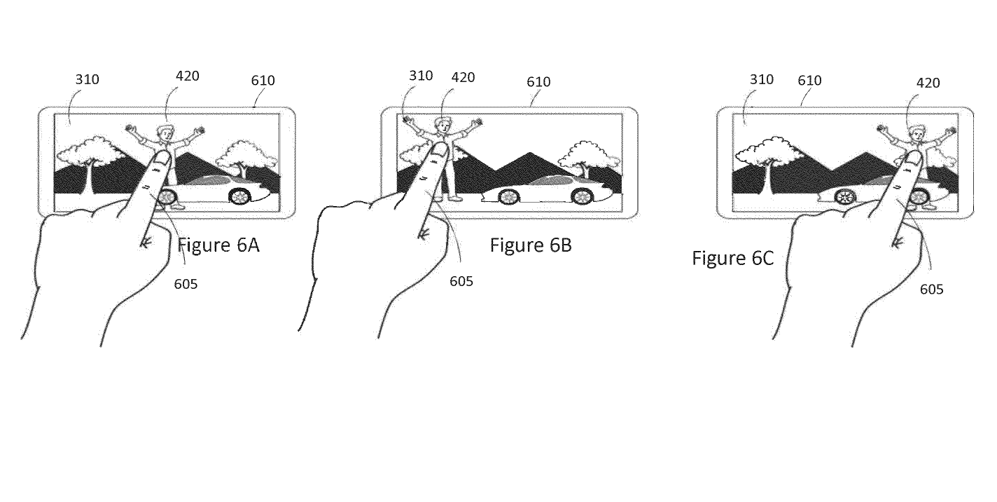

FIGS. 6A-6C show the person 420 of FIGS. 4A-4E composited into the image frame 310 of FIGS. 3A-3B. In FIG. 6A-6C, a user slides his or her finger 605 on a touchscreen device 610 to control the planar position of the object image 410. FIG. 6A shows the touchscreen device 610, the user's finger 605, the image frame 310 and the person 420 on the display of the touchscreen device 610. In FIG. 6A, the user touches the touchscreen device 610 with his or her finger 605 in the middle of the screen. FIG. 6B also shows the touchscreen device 610, the user's finger 605, the image frame 310 and the person 420 on the display of the touchscreen device 610. In FIG. 6B, the user slides his or her finger 605 to the left, and the person 420 moves to the left in planar position. FIG. 6C also shows the touchscreen device 610, the user's finger 605, the image frame 310 and the person 420 on the display of the touchscreen device 610. In FIG. 6C, the user slides his or her finger 605 to the right, and the person 420 moves to the right in planar position. The control input circuit 150 of FIG. 1 may receive the signal associated with the position of the user's finger 605 and send the signal to the motion tracking circuit 230. The motion tracking circuit 230 may determine where the compositing/editing circuit 250 will insert the object image 410. The processing circuit 130 may be configured to increment the (location of) pixels up to the point that the object image 410 no longer overlaps with the image frame 310. This may be accomplished by incrementing the pixel locations of image 410 with respect to the pixel locations of image 310 such that the composited result has the person 420 moving to the right up until the locations are greater than the pixel locations of the right edge of the image. On a PC, the user may control the position using a “drag and drop” operation from a pointing device such as a mouse. As seen in FIGS. 6A-C, the exemplary inserted person 420 is moved across the image frame 310 on the touchscreen device 610 while maintaining a set position in depth. On a gesture detection equipped device, a finger swipe in free space above the touchscreen device 610 may control the movement of the inserted person 420 to a new planar position.

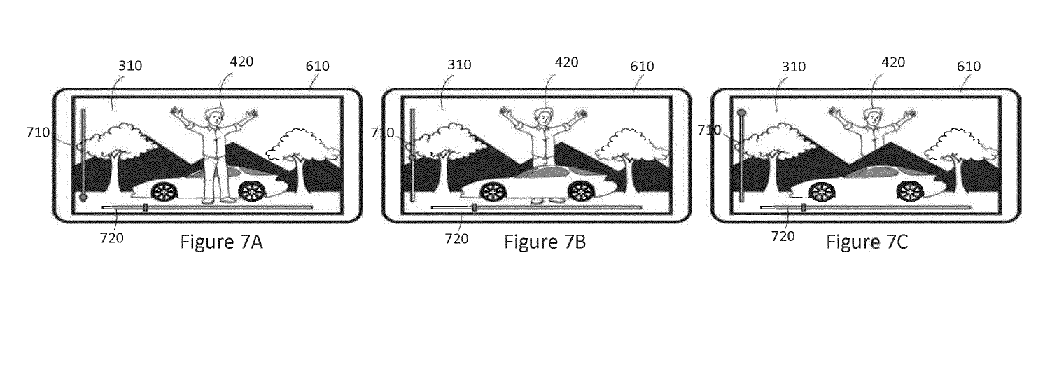

FIGS. 7A-7C show the person 420 and the image frame 310 of FIGS. 6A-6C, and an exemplary depth-based controller 710 (e.g., a slider) and an exemplary planar-based controller 720 on a touchscreen device 610. FIG. 7A shows the touchscreen device 610, the image frame 310 and the person 420 on the display of the touchscreen device 610, the vertical depth-based controller 710, and the horizontal planar-based controller 720. As shown in FIG. 7A, the position of the depth-based controller 710 is at the bottom, and the person 420 is in front of the car. FIG. 7B also shows the touchscreen device 610, the image frame 310 and the person 420 on the display of the touchscreen device 610, the vertical depth-based controller 710, and the horizontal planar-based controller 720. In this embodiment, the user has the ability to use the vertical depth-based controller 710 to change the depth of the person 420. The user also has the ability to use the horizontal planar-based controller 710 to change the planar position of the person 420. In FIG. 7B, as the position of the depth-based controller 710 moves to the middle, the person 420 moves behind the car but remains in front of the mountain terrain. FIG. 7C also shows the touchscreen device 610, the image frame 310 and the person 420 on the display of the touchscreen device 610, the vertical depth-based controller 710, and the horizontal planar-based controller 720. In FIG. 7C, when the position of the depth-based controller 710 is at the top, the person 420 moves behind the mountain terrain. The control input circuit 150, in FIG. 1, may receive the signal associated with the depth-based controller 710 and the planar-based controller 720. The control input circuit 150 may then send the signal to the motion tracking circuit 230 and/or the compositing/editing circuit 250 to be used in the compositing process. The depth-based controller 710 may be correlated to a depth position. The planar-based controller 720 may be correlated to a planar position. For example, the user controls the depth-based controller 710 by a finger swipe on a touchscreen device 610, by a mouse click on a PC, or by hand or finger motion on a gesture detection equipment device.

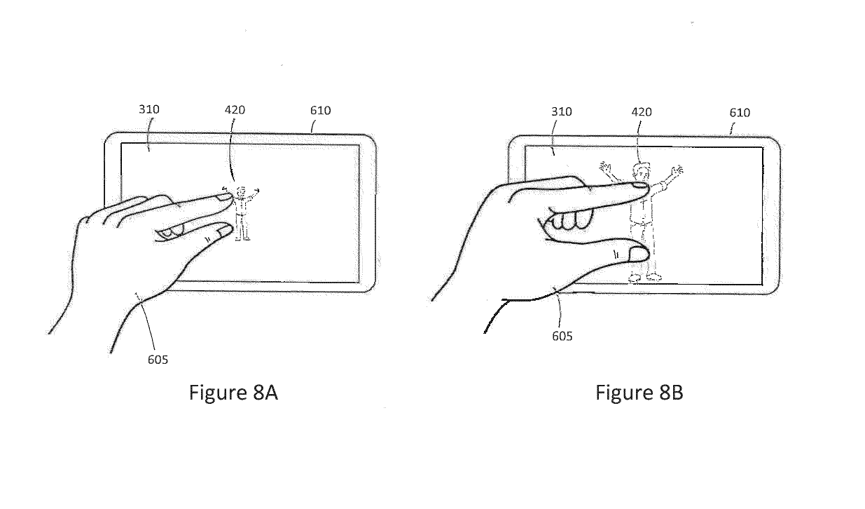

FIGS. 8A-8B shows the person 420 of FIGS. 6A-6C that is resized by movements of a user's fingers 605 while composited into the image frame 310. FIG. 8A shows the touchscreen device 610, the image frame 310 and the person 420 on the display of the touchscreen device 610, and the user's fingers 605. The user places his or her fingers 605 on the touchscreen device 610. The control input circuit 150, in FIG. 1, may receive the signal associated with motions from the user's finger 605. The control input circuit 150 may then send the signal to the motion tracking circuit 230 and/or the compositing/editing circuit 250 to be used in the compositing process. The user may control the size of the person 420 by sliding two fingers 605 on a touchscreen device 610 such that bringing the fingers closer together reduces the size and moving them apart increases the size. FIG. 8B also shows the touchscreen device 610, the image frame 310 and the person 420 on the display of the touchscreen device 610, and the user's fingers 605. FIG. 8B shows the user sliding his fingers 605 apart, and the person 420 increasing in size. The control input circuit 150 may also use a gesture detection equipped device. Additional tools may also be provided to enable the orientation and positioning of the object image 410 and/or image frame 310.

According to another embodiment, in a video sequence, the above controls manipulate the object image 410 as the image frame 310 is played back on screen. User actions may be recorded simultaneously with the playback. This allows the user to easily “animate” the inserted object image 410 within the video sequence.

The depth-based compositing system 100 may further be configured to allow the user to select a foreground/background mode for scene objects in the image frame 310. For example, the scene object selected as foreground will appear to lie in front of the object image 410, and the scene object selected as background will appear to lie behind the object image 410. This allows the object image 410 to not intersect with the scene object that spans a range of depth values.

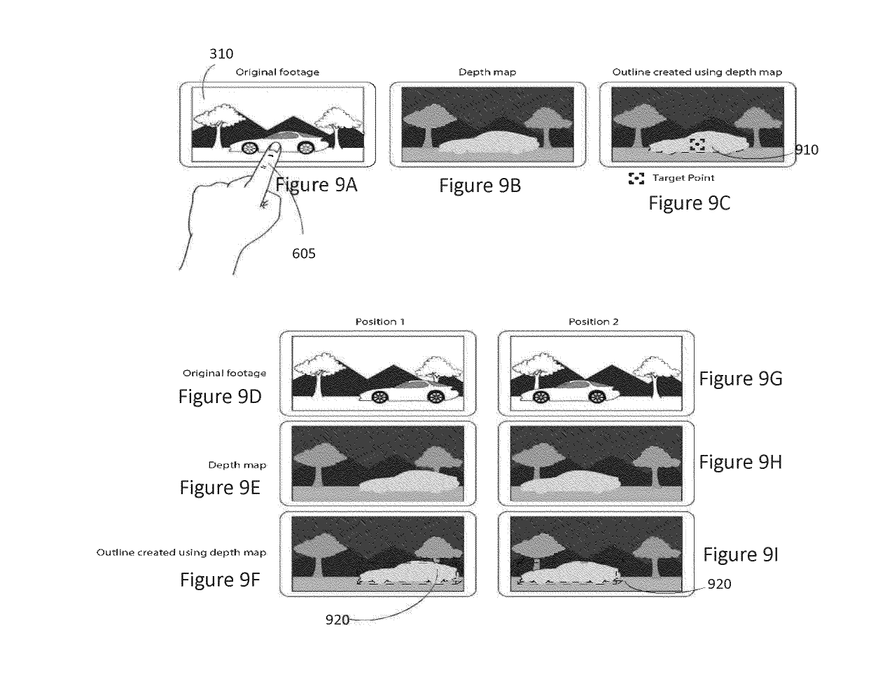

FIGS. 9A-9I show an exemplary selection of a scene object (the car) in the image frame 310 of FIGS. 3A-3B. FIG. 9A shows the image frame 310 and a user touching the car with his or her finger 605. A user may interface with the depth-based compositing system 100 using a touch input as shown in FIG. 9A, or a mouse input or gesture control input. FIG. 9B shows a depth map of the image frame 310 and differentiates each depth layer with a different color. In FIG. 9B, the processing circuit 130 extracts the depth-layers 320, 330, and 340. FIG. 9C shows a target point 910 that is created where the user touched the display with his or her finger 605 in FIG. 9A. The target point refers to the location in which the inserted object 410 (e.g., the person 420) is to be placed. The processing circuit 130 estimates a bounding cube (or rectangle) 920 around the touched target point 910 to identify an object (e.g., the car) around or associated with the target point, wherein the object falls inside the substantially bounding cube. To do so, the processing circuit 130 determines the horizontal (X) and vertical (Y) axis edges of the bounding cube 920 by searching in multiple directions around the target point 910 in the depth-layers 320, 330, and 340 of the image frame 310 until the gradient of the depth-layer 320, 330, and 340 is above a specified threshold. In one embodiment, the threshold may be set to some default value, and the end user may be given a control to adjust the threshold. The X and Y axis edges may be in the planar dimension. After the target point 910 is selected, the processing circuit 130 uses the depth map and tracks the depth layer of the target point 910. The processing circuit 130 then determines the depth (Z) axis edges of the bounding cube 920 as the maximum and minimum depths encountered during the search for X and Y edges. The Z axis edges may be in the depth dimension. In another embodiment, the processing circuit 130 may add additional tolerance ranges to the X, Y and Z edges of the bounding cube 920 to account for pixels in the depth-layers 320, 330, and 340 that may not have been tested during the search process. FIG. 9D shows another exemplary image frame 310 and the car in position 1. FIG. 9E shows the depth map of the image frame 310 of FIG. 9D. FIG. 9F show the bounding cube 920 created for the car in the image frame 310 of FIG. 9D in position 1. FIG. 9G shows another exemplary image frame 310 and the car in position 2. FIG. 9H shows the depth map of the image frame 310 of FIG. 9G. FIG. 9F show the bounding cube 920 created for the car in the image frame 310 of FIG. 9G in position 2. The processing circuit 130 receives image frames 310 as shown in FIGS. 9D and 9G, extracts the depth-layers 320, 330, and 340 of the image frames 310 as shown in FIGS. 9E and 9H, and identifies the bounding cube 920 where the car will become the foreground object. Once the target point 910 is selected by the user, the processing circuit 130 tracks the bounding cube 920 positioned around the object inside the bounding cube 920 (e.g., the car). The processing circuit 130 uses the bounding cube 920 to validate that the tracked target point 910 has correctly propagated from a first position (e.g., position 1) to a second position (e.g., position 2) using an image motion tracking technique. If the bounding cube 920 generated at position 2 does not match the bounding cube 920 at position 1, then the motion tracking technique may have failed, the object may have moved out of frame or to a depth layer that is not visible. In the event the inserted object 410 is connected to an object inside the bounding cube 920 that moves out of frame or to a depth layer that is not visible, then the inserted object 410 is deselected or removed from the image frame, and the inserted object 410 is no longer connected to the object inside the bounding cube 920.

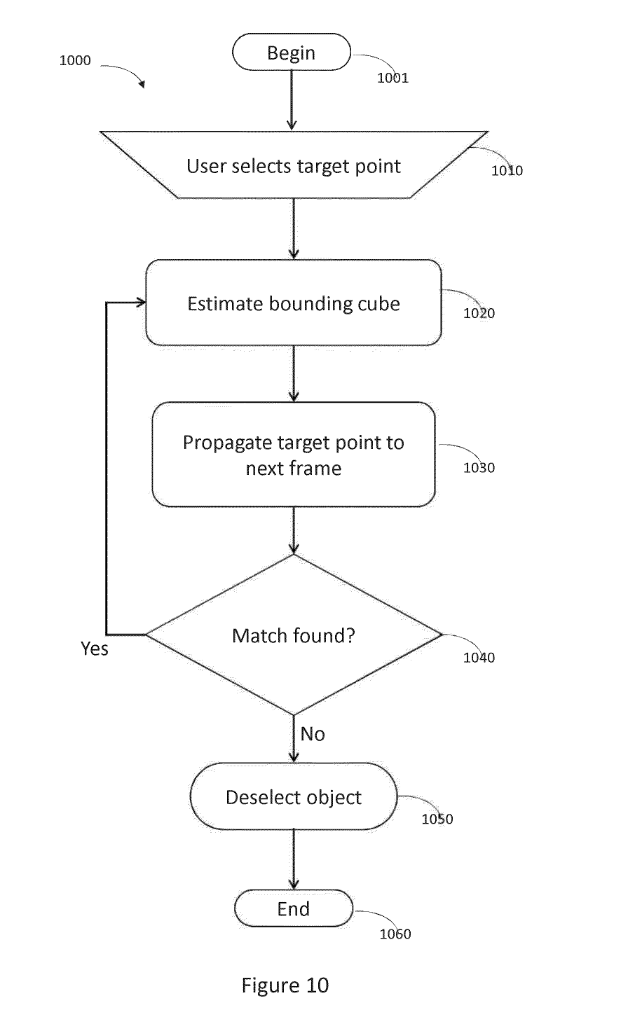

FIG. 10 is a flowchart 1000 of a method for updating the bounding cube 920 of the scene object in the image frame 310. At step 1001, the method begins.

At step 1010, the user selects the target point 910 of FIG. 9C.

At step 1020, the processing circuit 130 estimates the bounding cube 920 of FIG. 9F and FIG. 9I.

At step 1030, the processing circuit 130 propagates the target point 910 to the next frame in the image frame 310. For example, the processing circuit 130 may use a motion estimation algorithm to locate the target point 910 in a future frame of the image frame 310.

At step 1040, the processing circuit 130 locates a new target point 910 and performs a search around the new target point 910 to see if a match was found to obtain a new bounding cube 920 for the scene object. To determine if a match a found, the target point 910 selected by the user. Once the target point 910 is selected by the user, the processing circuit 130 tracks the bounding cube 920 positioned around the object inside the bounding cube 920 (e.g., the car). The processing circuit 130 uses the bounding cube 920 to validate that the tracked target point 910 has correctly propagated from a first position (e.g., position 1) to a second position (e.g., position 2) using an image motion tracking technique. If the bounding cube 920 generated at position 2 does not match the bounding cube 920 at position 1, then the motion tracking technique may have failed, the object may have moved out of frame or to a depth layer that is not visible. If a match was found, the processing circuit 130 performs step 1020 again.

The rendering of the object image 410 is based on the foreground/background selection of the scene object in the image frame 310 as well as the depth of the object image 410. If a match was not found, then the inserted object 410 may be connected to an object inside the bounding cube 920 that moved out of frame or to a depth layer that is not visible. At step 1050, the processing circuit 130 automatically deselects the inserted object 410 or removes the inserted object 410 from the image frame, and the inserted object 410 is no longer connected to the object inside the bounding cube 920. At step 1060, the method ends.

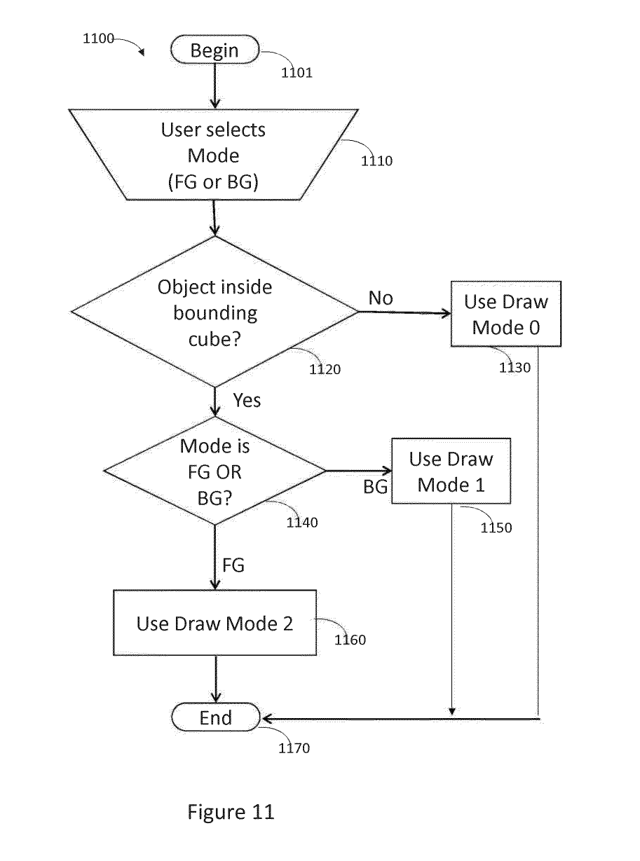

FIG. 11 shows a flowchart 1100 of a method for selecting draw modes for rendering scene objects composited into the image frame 310. Three different draw modes may be used for rendering the scene object depending on its position relative to the bounding cube 920 in the image frame 310 and the foreground/background selection of the scene object.

At step 1101, the method begins. At step 1110, the user selects foreground (“FG”) or the background (“BG”) for the scene object.

At step 1120, the processing circuit 130 determines whether the scene object is inside the bounding cube 920. If the scene object is not inside the bounding cube 920, then at step 1130, the processing circuit 130 will use Draw Mode 0. Draw Mode 0 is the default Draw Mode and it will be used if the object image 410 does not intersect with the bounding cube 920 of the scene object. Then, the object image is drawn as if its depth is closer than that of the image frame.

At step 1120, if the scene object is inside the bounding cube 920, then at step 1140, the processing circuit 130 determines whether the user selected FG or BG. If the user selected BG, then at step 1150, the processing circuit 130 will use Draw Mode 1. Draw Mode 1 is used if the object image 410 intersects with the bounding cube 920 of the scene object, and the user has specified that the scene object will be in the background. Then, the processing circuit 130 determines an intersection region, which is the intersection points of the object image 410 that lie within the bounding cube 920 and points in the scene objects that lie within the bounding cube 920. The object image 410 will appear in the composited drawing regardless of the specified depth of the scene object because the scene object will be in the background.

At step 1140, if the processing circuit 130 determines that the user selected FG, then at step 1160, the processing circuit will use Draw Mode 2. Draw Mode 2 is used if the object image 410 intersects the bounding cube 920 of the scene object, and the user specified the scene object as foreground. Then the processing circuit 130 determines the intersection region defined in step 1150. The image frame 410 will appear in the composited drawing regardless of the specified depth of the scene object because the scene object will be in the foreground. At step 1170, the method ends.

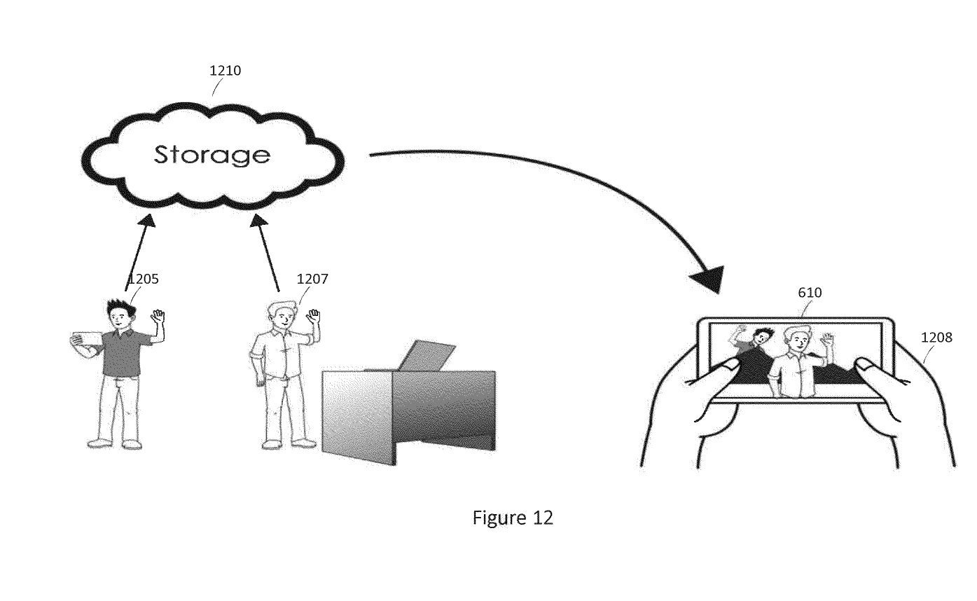

FIG. 12 shows exemplary insertions of multiple object images 410 composited into an image frame 310 using metadata. FIG. 12 shows a first individual 1205, a second individual 1207, a third individual 1208, a storage device 1210, and the touchscreen device 610 of FIG. 6. In one scenario, the first individual 1205 inserts himself into the image frame 310, and uploads the modified clip to the storage device 1210. Then, the first individual 1205 and then shares the modified clip with his/her friends and family. A second individual 1207 then inserts himself into the modified clip and sends the re-modified clip back to the storage device 1210 to share with the same group of friends and family, potentially including new recipients from the original circulation list. The third individual 1208 adds some captions in a few locations in the re-modified clip using the touchscreen device 610 and sends it back to the storage device 1210 again in an interactive process. Alternately, the depth-based compositing system 100 may be configured to save the modified clip on a storage device 1210 in a cloud server where the processing circuit 130 performs the additional edits on the composited modified clip, not a compressed distributed version. This eliminates the loss of quality that is likely with multiple compression and decompression of the clip as it is modified by multiple iterations of users. It also provides the ability to modify an insertion done by a previous editor. Rather than storing the composited result, the insertion location and size information may be saved for each frame of the clip. It is only when the user decides to post the result to a social network or email it to someone else that the final rendering is done to create a composited video that is compressed using a video encoder such as Advanced Video Coding (AVC) or Joint Photographic Experts Group (JPEG).

According to another embodiment, the depth-based compositing system 100 includes descriptive metadata that is associated with the shared result. The depth-based compositing system 100 may deliver this with the image frame 310, stored on a server with the source or delivered to a third party. One possible application is to provide information for targeted advertising. Given that feature extraction is part of the background removal process, demographic information such as age group, sex and ethnicity may be derived from an analysis of the captured person. This information might also be available from one of their social networking accounts. Many devices support location services so that the location of the captured person may also be made available. The depth-based compositing system 100 may include a scripted content that describes the content such as identifying it as a children's sing-a-long video. The depth-based compositing system 100 may also identify the image frame 310 from a sports event and the names of the competing teams along with the type of sport. In another example, if an object image 410 is inserted, the depth-based compositing system 100 provides information associated with the object image 410 such as the type of object, a particular brand or a category for the object. In particular, this may be a bicycle that fits in the personal vehicle category. An advertiser may also provide graphic representations of their products so that consumers may create their own product placement videos. The social network or networks where the final result is shared may store the metadata which may be used to determine the most effective advertising channels.

In the disclosure herein, information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Various modifications to the implementations described in this disclosure and the generic principles defined herein may be applied to other implementations without departing from the spirit or scope of this disclosure. Thus, the disclosure is not intended to be limited to the implementations shown herein, but is to be accorded the widest scope consistent with the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein may be downloaded and/or otherwise obtained by a user terminal and/or base station as applicable. For example, such a device may be coupled to a server to facilitate the transfer of means for performing the methods described herein. Alternatively, various methods described herein may be provided via storage means (e.g., RAM, ROM, a physical storage medium such as a compact disc (CD) or floppy disk, etc.), such that a user terminal and/or base station may obtain the various methods upon coupling or providing the storage means to the device. Moreover, any other suitable technique for providing the methods and techniques described herein to a device may be utilized.

While the foregoing is directed to aspects of the present disclosure, other and further aspects of the disclosure may be devised without departing from the basic scope thereof, and the scope thereof is determined by the claims that follow.

What is claimed is:

1. An apparatus for adding image information into at least one image frame of a video stream, the apparatus comprising:
a storage circuit storing depth information about first and second objects in the at least one image frame; and
a processing circuit configured to:
add a third object into a first planar position and at an image depth level of the at least one image frame based on selecting whether the first or second object is a background object,
maintain the third object at the image depth level in a subsequent image frame of the video stream, the image depth level being consistent with the selection of the first or second object as the background object, and
move the third object from the first planar position to a second planar position in a subsequent image frame of the video stream, the second planar position based at least in part on movement of an object associated with a target point.

2. The apparatus of claim 1, wherein the processing circuit is further configured to remove a background from a third image to produce the third object.

3. The apparatus of claim 2, wherein the third object comprises an image of a person, and the processing circuit is further configured detect and track the image of the person models a position of the person's torso and body.

4. The apparatus of claim 1, wherein the processing circuit is further configured to allow selection of the target point, propagate the target point to a new position in the subsequent image frame, and determine if another object associated with the target point at the new position matches the object associated with the target point.

5. The apparatus of claim 3, wherein the processing circuit is further configured to remove the third object from the subsequent image frame if the other object at the new position does not match the object associated with the target point.

6. The apparatus of claim 1, wherein the processing circuit is further configured to:
assign at least one pixel from the at least one image frame to fall in one of at least two depth layers of the at least one image frame,
determine a depth position for the at least two depth layers,
determine a planar position of the third object relative to the first and second objects of the at least one image frame,
determine a depth position of pixels of the third object relative to the at least two depth layers, and
replace pixels of the at least one image frame with the pixels of the third object that overlaps in the planar position with pixels in the first and/or second objects provided that the depth position of the pixel of the at least one image frame is behind the depth position of the pixel of the third object.

7. The apparatus of claim 1, wherein the processing circuit is further configured to:
determine a movement of the third object,
determine a movement of the first or second objects in the at least one image frame,
determine a relation of the movement of the third object to the movement of the first or second objects in the at least one image frame,
determine a location in the subsequent image frame to add the third object.

8. The apparatus of claim 1, wherein the processing circuit is further configured to:
extract metadata from the at least one image frame, the metadata comprising information about planar position, orientation, or the depth information of the at least one image frame, and
add the third object to the at least one image frame based on the metadata of the at least one image frame.

9. The apparatus of claim 1, wherein the processing circuit is further configured to:
obtain a bounding cube for the first object,
locate the target point in the subsequent image frame of the video stream,
perform a search around the target point to detect a subsequent bounding cube in the subsequent image frame, and
deselect the third object if the bounding cube of the subsequent frame does not match the bounding cube of the at least one image frame.

10. The apparatus of claim 1, wherein the processing circuit is further configured to:
create a pixel map of the third object,
determine a pixel spacing of the at least one image frame, and
change the pixel map of the third object to match the spacing of the at least one image frame.

11. The apparatus of claim 1, wherein the processing circuit is further configured to, before adding the third object into the at least one image frame, resize the third object to fit into a fourth object, combine the third object and the fourth object into a combined image, and add the combined image into the at least one image frame.

12. The apparatus of claim 8, wherein the processing circuit is further configured to maintain a composition of the combined image in the subsequent image frame of the video stream.

13. The apparatus of claim 1, further comprising a touchscreen interface configured to provide a depth-based position controller to control a depth location of the third object and a planar-based position controller to control a planar position of the third object.

14. The apparatus of claim 1, further comprising:
a recording circuit configured to store the at least one image frame with the added third object as a modified frame;
a tagging circuit configured to tag the stored modified frame with metadata that includes at least one of planar information, information orientation, or the depth information; and
a sharing circuit configured to share the modified image over a network.

15. The apparatus of claim 1, wherein the processing circuit is further configured to provide the object associated with the target point in guiding a user to insert the third object into the at least one image frame.

16. A method for adding image information into at least one image frame of a video stream, the method comprising:
storing depth information about first and second objects in the at least one image frame;
adding a third object into a first planar position and at an image depth level of the at least one image frame based on selecting whether the first or second object is a background object;
maintaining the third object at the image depth level in a subsequent image frame of the video stream, the image depth level being consistent with the selection of the first or second object as the background object; and
moving the third object from the first planar position to a second planar position in a subsequent image frame of the video stream, the second planar position based at least in part on movement of an object associated with a target point.

17. The method of claim 16, further comprising allowing selection of a target point, propagating the target point to a new position in the subsequent image frame, and determining if another object associated with the target point at the new position matches the object associated with the target point.

18. The method of claim 16, further comprising:
assigning at least one pixel from the at least one image frame to fall in one of at least two depth layers of the at least one image frame;
determining a depth position for the at least two depth layers;
determining a planar position of the third object relative to the first and second objects of the at least one image frame;
determining a depth position of pixels of the third object relative to the at least two depth layers; and
replacing pixels of the at least one image frame with the pixels of the third object that overlaps in the planar position with pixels in the first and/or second objects provided that the depth position of the pixel of the at least one image frame is behind the depth position of the pixel of the third object.

19. An apparatus for adding image information into at least one image frame of a video stream, the apparatus comprising:
means for storing depth information about first and second objects in the at least one image frame;
means for adding a third object into a first planar position and at an image depth level of the at least one image frame based on selecting whether the first or second object is a background object;
means for maintaining the third object at the image depth level in a subsequent image frame of the video stream, the image depth level being consistent with the selection of the first or second object as the background object; and
means for moving the third object from the first planar position to a second planar position in a subsequent image frame of the video stream, the second planar position based at least in part on movement of an object associated with a target point.

20. The apparatus of claim 19, further comprising:
means for assigning at least one pixel from the at least one image frame to fall in one of at least two depth layers of the at least one image frame;
means for determining a depth position for the at least two depth layers;
means for determining a planar position of the third object relative to the first and second objects of the at least one image frame;
means for determining a depth position of pixels of the third object relative to the at least two depth layers; and
means for replacing pixels of the at least one image frame with the pixels of the third object that overlaps in the planar position with pixels in the first and/or second objects provided that the depth position of the pixel of the at least one image frame is behind the depth position of the pixel of the third object.
